(19) United States
(12) Patent Application Publication
(10) Pub. No.: US 2015/0109876 A1
(43) Pub. Date: Apr. 23, 2015

(54) MIXING APPARATUS

(71) Applicant: Jesica Temple, White Sulphur Springs, WV (US)

(72) Inventor: Jesica Temple, White Sulphur Springs, WV (US)

(21) Appl. No.: 14/061,111

(22) Filed: Oct. 23, 2013

(51) Int. Cl. B01F 13/00

(52) U.S. Cl. CPC B01F 13/00
USPC 366/130

(57) ABSTRACT

A mixing apparatus is for selective mixing of contents. The mixing apparatus has a body that defines an interior space. The body further has an aperture for permitting access to the interior space. The body has at least a portion that is collapsible and configured to be gripped and repositioned by a user to collapse a part of the body into the interior space to alter at least one of: the volume of the interior space; and the shape of the interior space. The mixing apparatus further has at least one mixing member located within the interior space that is configured and located so that the contents is forced against the at least one mixing member when the collapsible portion is gripped and repositioned by a user.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to a mixing apparatus or container.

### BACKGROUND OF THE INVENTION

A mixing apparatus is employed to provide for selective mixing or combining any number or combination of fluids and solids. Such an apparatus is especially of use to a user interested in mixing a dosage of medication or mixing a dietary supplement. Various substances (such as medicine, food items, creams, granules, liquids, gels, powders, small articles, etc.) may be selectively added to a mixing apparatus having an aperture that can be opened, closed, or otherwise occluded.

A typical mixing apparatus has a body wherein contents can be stored, an aperture to access the contents, and a means (e.g., cap, seal, or other suitable cover) to occlude the aperture during the mixing process. Further, the typical mixing apparatus for performing the aforementioned tasks is a container with a body that is rigid or otherwise formed from a bulky, non-collapsible material to aid in mixing the contents of the container. It may be difficult for a user of such a typical rigid container to wash or otherwise reuse the container in a hygienic manner.

A mixing apparatus may have the form of a flexible pouch that is less bulky than the aforementioned rigid-type container. Such a flexible pouch may have the advantage of being less expensive, more easily transported by a user. The pouch may also be more readily disposed. However, such a flexible pouch may suffer from the inability to effectively mix the stored contents.

The Applicant has invented a novel structure for a mixing apparatus, wherein the apparatus includes advantageous features not heretofore taught or contemplated by the prior art.

### SUMMARY OF THE INVENTION

It is desirable to provide a mixing apparatus for hygienic, efficient, and convenient mixing of the contents of the mixing apparatus. Such a mixing apparatus will motivate a user to take medicine, supplements, or other contents while providing a mixture that is substantially homogenous, with few clumps and ready for consumption by the user. The presently disclosed mixing apparatus, and method of use thereof, satisfies one or more of these needs.

In one inventive form, a mixing apparatus is provided for selective mixing of contents by a user of the mixing apparatus. The mixing apparatus has a body that defines an interior space. The body further has an aperture for permitting access to the interior space. The body has at least a portion that is collapsible and configured to be gripped and repositioned by a user to thereby collapse a part of the body into the interior space to alter at least one of: (1) a volume of the interior space; and (2) a shape of the interior space. The mixing apparatus further has at least one mixing member located within the interior space configured and located so that the contents is forced against the at least one mixing member when the collapsible portion is gripped and repositioned by a user.

In another inventive form, the mixing apparatus is further provided with a fluent contents located within the interior space of the mixing apparatus.

In another inventive form of the mixing apparatus, the collapsible portion is made from a flexible material.

In another inventive form of the mixing apparatus, the at least one mixing member is a vane.

In another inventive form of the mixing apparatus, the vane is in the form of an arcuate fin.

In another inventive form of the mixing apparatus, the at least one mixing member and the body are formed from the same material.

In another inventive form of the mixing apparatus, the at least one mixing member extends from an interior surface of the body toward the interior space a distance of at least one quarter of an inch.

In yet another inventive form of the mixing apparatus, the at least one mixing member and the body are formed from the same material, the mixing member being located at the collapsible portion.

In another inventive form of the mixing apparatus, the at least one mixing member is attached to the body along an interior surface to assist the body in freely-standing.

In another inventive form, the mixing apparatus further comprises at least two mixing members extending within the interior space in a V-shaped configuration.

In another inventive form, the mixing apparatus further comprises a fastener proximal the aperture. The fastener is for selectively opening and closing of the aperture by a user.

In another inventive form, the mixing apparatus further comprises a plurality of interlocking ribs for resealable opening and closing of the aperture.

In yet another inventive form, the mixing apparatus further comprises at least one gusset formed in the body.

In another inventive form, the mixing apparatus further comprises a plurality of resealable surfaces proximal the aperture. The resealable surfaces are configured for repeated opening and closing of the aperture.

In another inventive form, the mixing apparatus further comprises a utensil having a first end configured for communication with the contents in the interior space of the mixing apparatus. The utensil further has a second end configured for being manipulated by a user.

In another inventive form, the mixing apparatus further comprises at least one marking structure located on a surface of the body. The marking structure is configured to allow for a volumetric measurement of the contents of the mixing apparatus.

In another inventive form, the mixing apparatus further comprises an absorbent surface located on an exterior surface of the body. The absorbent surface configured to retain a marking substance for permanent marking of the mixing apparatus by a user.

In yet another inventive form of the mixing apparatus, the at least one mixing member is bonded to the body.

In yet another inventive form of the mixing apparatus, the at least one mixing member extends at least partially along a perimeter an interior surface of the body.

In yet another inventive form, a method is provided for using the mixing apparatus, the method comprises the steps of: (1) providing the mixing apparatus; (2) providing contents within the mixing apparatus; (3) gripping the mixing apparatus; (4) and applying a force to collapse the body at the collapsible portion of the mixing apparatus, so as to force the contents to be directed against the at least one mixing member of the mixing apparatus to mix the contents.

Other objects, features, and advantages of the invention will become apparent from a review of the entire specification, including the appended claims and drawings.

### BRIEF DESCRIPTION OF THE DRAWINGS

FIG. 1 is an exterior perspective view of a first embodiment of a mixing apparatus.

FIG. 2 is a cross-sectional view along plane 2-2 of the mixing apparatus illustrated in FIG. 1.

FIG. 3 is a detailed cross-sectional view along plane 3-3 of the mixing apparatus illustrated in FIG. 2.

FIG. 4 is an exterior perspective view of another embodiment of a mixing apparatus.

FIG. 5 is a cross-sectional view along plane 5-5 of the mixing apparatus illustrated in FIG. 4.

FIG. 6 is a schematic view of another embodiment of a mixing apparatus.

FIG. 7 is a flow diagram of a method of using an embodiment of a mixing apparatus.

### DETAILED DESCRIPTION OF THE PREFERRED EMBODIMENT

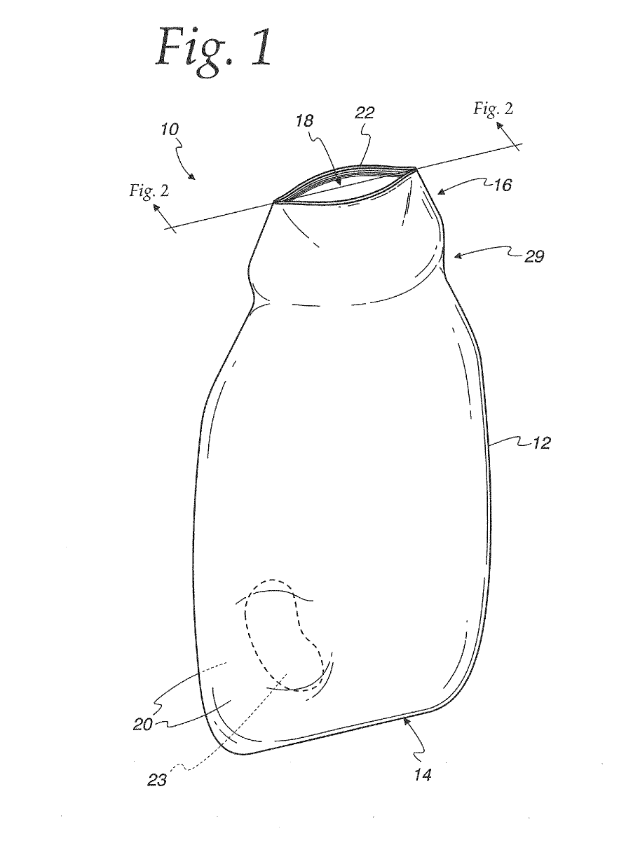

FIG. 1 shows an exterior perspective view of a first embodiment of a mixing apparatus 10. The mixing apparatus 10 has a body 12. The body 12 preferably has a first end 14 and a distal second end 16. The body 12 defines an interior space 18. The body is preferably formed by a plurality of walls 20. An aperture 22 is provided within the body 12. The aperture 22 is preferably located proximal the distal second end 16 of the body 12 for permitting access to the interior space 18. The body 12 may be provided with an empty interior space 18 or may be filled with a fluent contents 23 during manufacture of the mixing apparatus 10. The fluent contents 23 may be one or more fluent material, such as a liquid, cream, gel, powder, or granule.

The body 12 may be made of any food, medicine, or other consumable-safe polymer, foil, or layered combination thereof. In a presently preferred embodiment, the body 12 is made from a flexible polymer. The mixing pouch 10 may be formed by bonding (welding or adhering) portions of two parallel sheets of polymer to create the plurality of walls 20, including any number of side walls 24, bottom walls 26 proximal the first end 14, and/or top walls 28 proximal the distal second end 16. Adhesives or other similar means may alternatively be utilized in lieu of welding of the body 12 to form the plurality of walls 20.

As can further be seen in FIG. 1, the first illustrated embodiment of the mixing apparatus 10 has a body 12 with a collapsible portion 29 configured to be gripped and repositioned by a user to thereby collapse a part of the body 12 into the interior space 18. The collapsible portion 29 may be a weakened portion of the body 12 in comparison to the remainder of the body 12. Weakening of the collapsible portion may be achieved through utilization of a thinner material, weaker material, or other suitable means to enable collapse of the body 12. As will be discussed in detail below, the collapse of at least part of the body 12 alters at least one of: (1) a volume of the interior space 18; and (2) a shape of the interior space 18.

FIG. 2 is a cross-sectional view taken along plane 2-2 of the first illustrated embodiment of the mixing apparatus 10. The mixing apparatus 10 further has at least one mixing member 30 located within the interior space 18 configured and located so that the contents 23 (not illustrated) is forced against the at least one mixing member 30 when the collapsible portion 29 is gripped and repositioned by a user. In the first illustrated embodiment of mixing apparatus 10, there are a plurality of mixing members 30 running generally from the first end 14 toward the distal second end 16. As will be discussed in detail below, it will be apparent to one having ordinary skill in the art that the path and placement of the mixing members 30 may vary from the generally longitudinal direction between the first end 14 and distal second end 16. The mixing members 30 may have the form of a rigid vane 31 that is bonded, welded, adhered, or similarly attached to one or more of the plurality of walls 20. It is preferred that the mixing vane 31 be made of a food-safe polymer that is generally more rigid than the material selected for the body 12.

As further shown in FIG. 2, the mixing apparatus 10 may have a plurality of resealable fastener portions 32 proximal the aperture 22. The fastener portions 32 are configured for selective opening and closing of the aperture 22 by a user of the mixing apparatus 10. The fastener portions 32 may have the form of interlocking ribs. The fastener portions 32 may be heat welded, adhered, or similarly affixed proximal the aperture 22. Alternatively, the aperture 22 may be provided with a plurality of resealable surfaces 33 proximal the aperture 22 for repeated opening and self-sealing of the aperture 22. The self-sealing capability may be the result of one or more adhesive layers applied to the body 12 or natural cohesion of the material selected for the body 12.

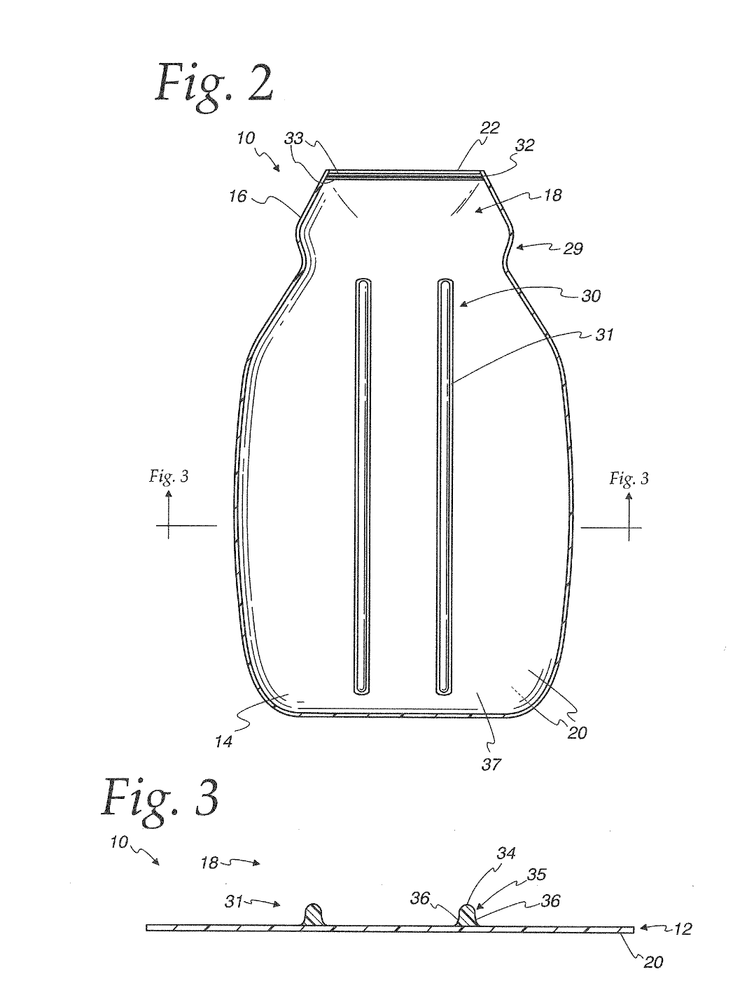

FIG. 3 is a detailed cross-sectional view taken along plane 3-3 in FIG. 2 and further illustrates the presently preferred geometry of the mixing vane 31. The mixing member 31 has a maximum point 34 located at a furthest distance from the body 12 in the direction of the interior space 18. The mixing vane 31 may extend at least one quarter, and preferably three-eighths, of an inch from the body 12 toward the interior space 18.

In the first embodiment of mixing apparatus 10 as illustrated in FIG. 3, the mixing vane 31 has the form of an arcuate fin 35. The arcuate fin 35, has a pair of concave surfaces 36 on either side of the maximum point 34. The concave surfaces 36 may have the same or differing length radii. It will be understood to one having ordinary skill in the art that the mixing vane 31 may have a cross-section in the form of a triangle, square, or other polygon. Further, the mixing vane 31 may contain any number of voids or discontinuities along its length.

It will be understood that the mixing apparatus 10 may have one or more mixing members 30 arranged in a variety of locations within the interior space 18. For example, the mixing apparatus 10 may comprise two mixing members 30 diagonally-extending within the interior space 18 in the form of a “V”.

As can be seen in FIG. 2, the mixing members 30 may be attached to the body 12 along an interior surface 37 to assist the mixing apparatus 10 in freely-standing. When one of the first end 14 and distal second end 16 rests upon a surface, the mixing member 30 in the form of a rigid mixing vane 31 provides a structural support for the body 12. However, in the broadest concept of the present invention, it will be apparent to one having ordinary skill in the art that the mixing members 30 need not be positioned to aid the mixing apparatus 10 in freely-standing.

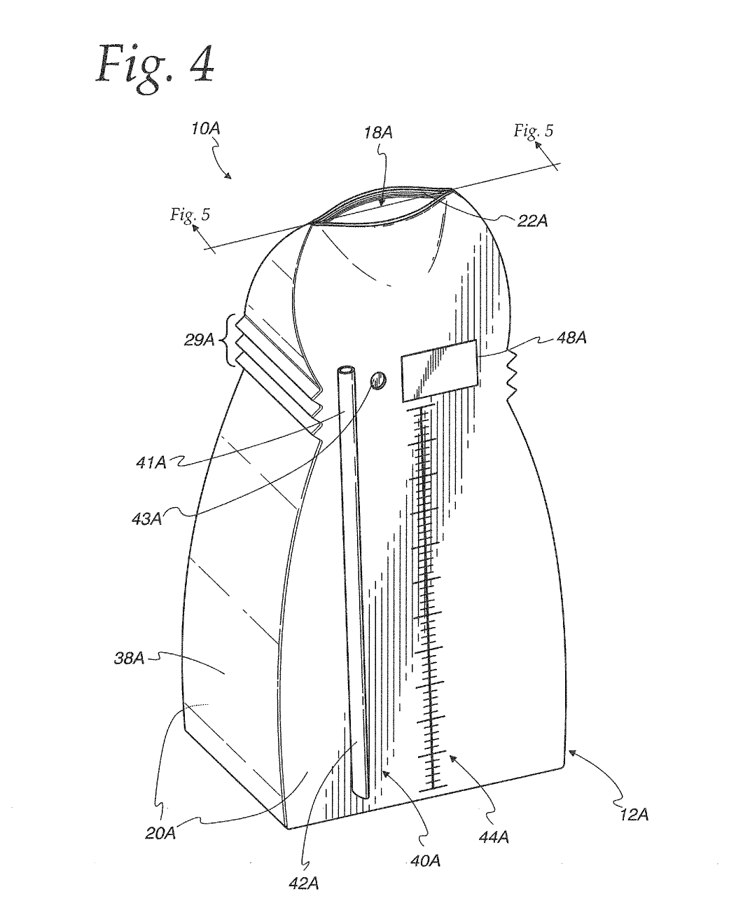

Another embodiment of mixing apparatus 10A can be seen in FIG. 4, an exterior perspective illustration. Mixing apparatus 10A is similar to that of the first embodiment 10, except that mixing apparatus 10A has a body 12A with one or more gussets 38A, or expandable chambers. The gusset 38A is utilized for increasing the interior space 18A of the mixing pouch 10A. The gusset 38A may be formed by folding one or more of the plurality of walls 20A during formation of the mixing apparatus 10A as described in the preceding sections. It will be appreciated by one having ordinary skill in the art that the gusset 38A is not limited to mixing pouch 10A and may be formed in any of the embodiments discussed herein.

As shown in FIG. 4, the mixing apparatus 10A, may have a utensil 40A adapted to remove, mix, or otherwise interact with the contents of the mixing appratus 10A. The utensil 40A a utensil has a first end 41A configured for communication with the contents 29A (not illustrated) in the interior space 18A of the mixing apparatus 10A. The utensil 40A further has a second end 42A configured for being manipulated by a user. The utensil 40A may be a spoon, straw, mixing rod, or similar device to accomplish one of the aforementioned tasks. The utensil 40A may access the interior space 18A via the aperture 22A or a utensil aperture 43A that is generally smaller in area than aperture 22A. The utensil 42A may be adhered, welded, or friction fit to detachably communicate with the exterior surface of the body 12A.

FIG. 4 further shows that the mixing apparatus 10A may have a least one marking structure 44A located on the body 12A. The at least one marking structure 44A is configured to measure the contents 29A (not illustrated) of the mixing apparatus 10A. The at least one marking structure 44A is located on a surface 46A of the body 12A. A portion of the body 12A is transparent or opaque such that a user may view the contents through the body 12A of the mixing apparatus 10A. The marking structure 44A may have any unit of volumetric measurement, such as standard or SI units, and is preferably calibrated to accurately measure volume when the mixing apparatus 10A has a maximum interior space 18A.

FIG. 4 further shows that the mixing pouch 10A may have an absorbent surface 48A located on an exterior surface of the body 12A for permanent marking of the mixing apparatus 10A by a user. It is preferable that the absorbent surface 46A provide for irreversible, non-wipable marking of the mixing apparatus 10A such that a marking substance 49A, such as ink or dye provided by a user, is absorbed into the surface 48A.

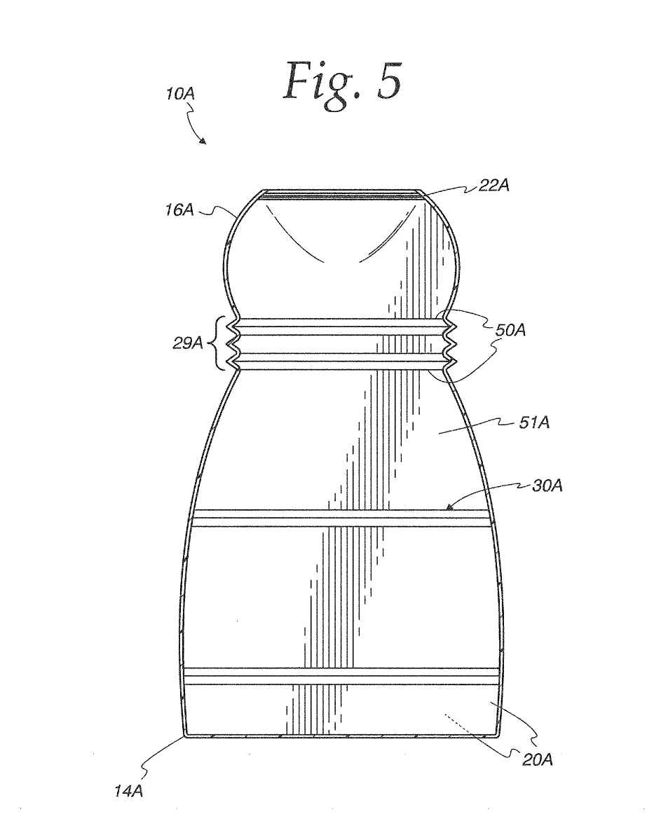

FIG. 5 is a cross-sectional view, taken along plane 5-5 in FIG. 4, of mixing apparatus 10A. Mixing apparatus 10A may have at least one integral mixing member 50A that is integral with, or formed from the same material as, the body 12A. The integral mixing member 50A may further be located at the collapsible portion 29A of said body 12A. The integral mixing member 50A may be formed by the same aforementioned processes used to form the collapsible portion 29A, such as folding, heat treating, adhering, or pressure treating the body 12A material. Although not illustrated, it will be appreciated that any of the mixing apparatuses described herein may be provided with one or more integral mixing member 50A.

In the embodiment of the mixing pouch 10A, illustrated in FIG. 5, there is at least one mixing member 30A extending at least partially along a perimeter of an interior surface 51A of the body 12A. The perimeter of the body 12A is generally defined as any closed path along any surface 51A of the body 12A within the interior space 18A. As illustrated, the mixing member is extending in a generally horizontal direction (the vertical direction being defined by a line between the first end 14A and the distal second end 16A). The cross-sectional profile of the at least one mixing member 30A may be the same as that discussed with regard to mixing member 30.

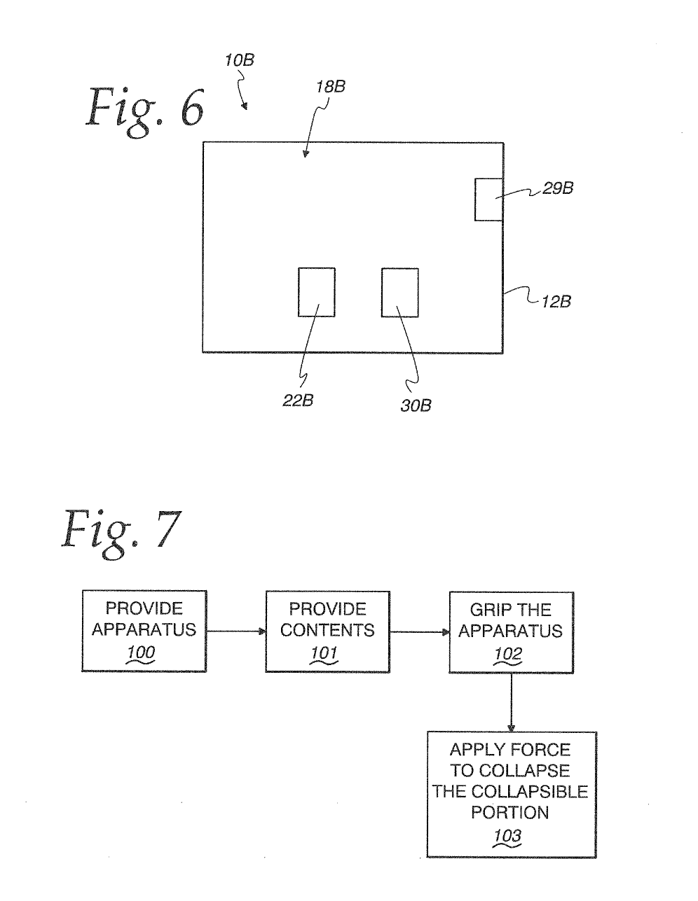

FIG. 6 illustrates a most basic embodiment of the inventive mixing apparatus 10B disclosed herein. Embodiment 10B is the same in all respects as the prior embodiments, with a body 12B defining an interior space 8B and an aperture 22B therein. The body 12B further has a collapsible portion 29B and at least one mixing vane 30B. FIG. 6 illustrates that the most basic concept of the present invention is not limited to any particular illustrated geometry.

In the typical method of use is illustrated basically in FIG. 7. Box 100 depicts the first step of the method, in which a user first provides a mixing apparatus 10. Box 101 depicts a second step of the method wherein the user provides contents 23 to be mixed in the interior space 18. If provided, the user may measure the contents with the marking structure 44A and mark the nature of the contents on the absorbent surface 48A. The user occludes the aperture 22, by the fastener portion 32 if provided, and grips the mixing apparatus 10A at the collapsible portion 29, as depicted in box 102. As depicted in box 103, the user will shake the mixing apparatus 10A forcing the contents 29 to pass over the at least one mixing member 30, and the integral mixing member 50A if provided. The mixing vane 30 and integral mixing vane 50A allow for increased and efficient agitation of the contents. Such agitation reduces the time to mix the contents 29 and provides for a generally more homogenous mixture. As the user shakes the mixing apparatus 10, the user exerts a force on the collapsible portion 29, collapsing the body 12 inward. This secondary motion increases the agitation of the mixed contents 29, decreasing time required to mix the contents 29.

The typical method of use of mixing apparatus 10, 10A, and 10B are identical.

1. A mixing apparatus for selective mixing of a contents, said mixing apparatus comprising:
a. a body defining an interior space, said body further having an aperture for permitting access to said interior space, said body having at least a portion that is collapsible and configured to be gripped and repositioned by a user to thereby collapse a part of said body into said interior space to alter at least one of: (1) a volume of said interior space; and (2) a shape of said interior space; and
b. at least one mixing member located within said interior space, the mixing member configured and located so that the contents is forced against said at least one mixing member when said collapsible portion is gripped and repositioned by a user.

2. The mixing apparatus of claim 1 further comprising:
a. a contents in the form of a fluent material within said interior space of said mixing apparatus.

3. The mixing apparatus of claim 1, wherein said collapsible portion is made from a flexible material.

4. The mixing apparatus of claim 1, wherein said at least one mixing member comprises a vane.

5. The mixing apparatus of claim 4, wherein said vane is in the form of an arcuate fin.

6. The mixing apparatus of claim 1, wherein said at least one mixing member and said body are formed from the same material.

7. The mixing apparatus of claim 1, wherein said at least one mixing member extends from an interior surface of said body toward said interior space a distance of at least one quarter of an inch.

8. The mixing apparatus of claim 1, wherein said at least one mixing member and said body are formed from the same, and said at least one mixing member is located at said collapsible portion.

9. The mixing apparatus of claim 1, wherein said at least one mixing member is attached to said body along an interior surface to assist said body in freely-standing.

10. The mixing apparatus of claim 1, further comprising:
a. at least two mixing members extending within said interior space in a V-shaped configuration.

11. The mixing apparatus of claim 1, further comprising:
a. a fastener on said body proximal said aperture, said fastener for selectively opening and closing of said aperture by a user.

12. The mixing apparatus of claim 11, wherein said fastener comprises a plurality of interlocking ribs for resealable fastening of said aperture.

13. The mixing apparatus of claim 1, further comprising:
a. at least one gusset formed in said body.

14. The mixing apparatus of claim 1, further comprising:
a. a plurality of resealable surfaces proximal said aperture, said resealable surfaces configured for repeated opening and closing of said aperture.

15. The mixing apparatus of claim 1, further comprising:
a. a utensil in communication with said body, said utensil having a first end configured for communication with the contents in said interior space, and said utensil having a second end configured for being manipulated by a user.

16. The mixing apparatus of claim 1, further comprising:
a. at least one marking structure located on a surface of said body, said marking structure located to allow for a volumetric measurement of the contents of said mixing apparatus.

17. The mixing apparatus of claim 1, further comprising:
a. an absorbent surface located on an exterior surface of said body, said absorbent surface configured to retain a marking substance for permanent marking of said mixing apparatus by a user.

18. The mixing apparatus of claim 1, wherein said at least one mixing member is bonded to said body.

19. The mixing apparatus of claim 1, wherein said at least one mixing member extends at least partially along a perimeter of an interior surface of said body.

20. A method of using the mixing apparatus of claim 1, said method comprising the steps of:
a. providing a mixing apparatus as in claim 1;
b. providing a contents within said mixing apparatus;
c. gripping said mixing apparatus; and
d. applying a force to collapse said body at said collapsible portion, so as to force said contents to be directed against said at least one mixing member to mix said contents of said mixing apparatus.
